(19) United States
(12) Patent Application Publication
(10) Pub. No.: US 2002/0194018 A1
(43) Pub. Date: Dec. 19, 2002

(54) Method for matching complimentary business interests

(76) Inventor: Gene Scott, Costa Mesa, CA (US)

Correspondence Address: GENE SCOTT, PATENT LAW & VENTURE GROUP ITTT, 3151 AIRWAY AVE, SUITE K 105, COSTA MESA, CA, 92626, US

(21) Appl. No.: 10/223,776

(22) Filed: Aug. 19, 2002

Related U.S. Application Data
(63) Continuation-in-part of application No. 09/586,710, filed on Jun. 5, 2000.

(51) Int. Cl. G06F 17/60

(52) U.S. Cl. 705/1

(57) ABSTRACT

A method matches complementary interests of business entities, and includes creating a business entity database wherein each record in the database contains information about a single business entity, i.e., a firm, company, organization, individual, group, etc. Each record includes the name of the business entity, contact information, and what the entity seeks from, and what it offers to, the business community. Additionally, each entity is identified by its primary SIC number, which represents the industrial area most relevant to the business activities or technology of the entity. Business entities identify what products, services, capital, or technology they offer, or may be interested in acquiring. The method provides public access to the database for listing new entities in the database and for public searching in the database to find entities offering what is sought by the searcher, and to find those that seek what the searcher offers. Each searcher identifies what is sought and an SIC number representing the primary industrial area of interest. A logic algorithm searches and matches complementary interests and provides contact information to the searcher in the form of a list for selection by the searcher.

### RELATED APPLICATIONS

This is a continuation-in-part application of a prior filed and currently pending application having Ser. No. 09/586,710 and file date of Jun. 5, 2000.

### INCORPORATION BY REFERENCE

Applicant(s) hereby incorporate herein by reference, any and all U.S. patents, U.S. patent applications, and other documents and printed matter cited or referred to in this application.

### BACKGROUND OF THE INVENTION

1. Field of the Invention

This invention relates generally to business methods, and more particularly to a method for matching complimentary business interests using a database open to the public via the Internet.

2. Description of Related Art

The prior art teaches the use of large scale database availability via the Internet for providing data to users, subscribers and to the general public. Technical information and data is available via the Internet on the USPTO.gov web site where patent and trademark information may be search out, read and downloaded. Also, intellectual properties (IP) of all types may be found on many Internet web sites. Such sites provide summary information or complete descriptions of issued patents, etc. Likewise, business information may be found on hundreds of sites. An IP holder may search-out an appropriate business that may be related to his/her creative efforts using several business registries such as Dun & Bradstreet, Inc. Million Dollar Directory and the Thomas Registry. Businesses seeking new technical development may find such in the listings described above. However, certain drawbacks exist in using these sources. Such problems prevent a truly effective matching between IP on the one side and business needs on the other. The primary problem is that there is a vast amount of IP created each year and most of it cannot be publicly divulged without loss of certain IP rights as well as commercial benefits. Also, there does not exist a truly effective way for matching since IP holders do not identify their works by a commonly used business code system such as the SIC used in business. Finally, much IP does not have the significant benefits that business looks for in a commercially viable new product or technology, business method, etc. The instant invention overcomes these problems to provide a truly significant advantage to both the IP creator as well as the business executive. The present invention fulfills this need and provides further related advantages as described in the following summary.

References sited in the parent application include:

Donner, U.S. Pat. No. 6,263,314 describes a method of performing an intellectual property (IP) audit estimating a value of an intellectual property portfolio. The method includes the steps of analyzing the IP portfolio, and deriving first information responsive to said analyzing step based upon the IP portfolio. The method also includes the steps of retrieving empirical data relating to known IP portfolios, and comparing the first information to the empirical data producing an IP worth indicator indicating an estimated worth of the IP portfolio. The method is optionally implementable over a network architecture.

Germeraad et al., U.S. 2002/0035499 describes patent-related tools, and methodologies involving those tools, for assisting in all stages of the merger and acquisition process. The IPAM server may be used in conjunction with the tools and methodologies to aid in the merger and acquisition process. These tools or methods include, but are not limited to, a topographic map, a technology classification, a SIC classification, a radar diagram, a patent citation tree, a citation root tree, a citation count report, a citation frequency graph, a citation frequency report, a patent count/year, an application count/year, a patent aging graph, a U.S. primary class/subclass, an international patent class, an assignee patent count report by primary class/subclass, a patent count graph by number of patents, a top assignees primary class/subclass by percent of total, a months to issue patents, a features grouping, a document annotation, an inventor patent count/assignee, an inventor patent count graph, and inventor data.

SICCODE.com, an Internet site that enable a user to search for companies in a particular SIC number and to read about the products or services offered by the company, but does not teach the inclusion of a short list of the assets that are offered by and also those sought by each company. This critical distinguishing feature is of paramount importance and enables the present invention to accomplish what SICCODE.com cannot, i.e., large scale matching of businesses registered in the database. SICCODE.com also does not teach the use of matching business needs for technology with new technology offerings using the SIC coding system.

### SUMMARY OF THE INVENTION

The present invention is a method for matching complementary interests of business entities, and includes creating a business entity database wherein each record in the database contains information about a single business entity, i.e., a firm, company, organization, individual, group, etc. Each record includes the name of the business entity, contact information, and what the entity seeks from, and what it offers to, the business community. Additionally, each entity is identified by its primary SIC number, which represents the industrial area most relevant to the business activities or technology of the entity. Business entities identify what products, services, capital, or technology they offer, or may be interested in acquiring. The method provides public access to the database for listing new entities in the database and for public searching in the database to find entities offering what is sought by the searcher, and to find those that seek what the searcher offers. Each searcher identifies what is sought and an SIC number representing the primary industrial area of interest. A logic algorithm searches and matches complementary interests and provides contact information to the searcher in the form of a list for selection by the searcher. Clearly, Internet sites such as SICCODE.com, sited above, provide a means for searching for and finding business entities in a selected SIC classification, and of discovery of products and services provided by these entities. However, the present invention method, in identifying the general asset categories, from a limited and fixed list of such categories, of those assets sought and offered, enables all of the entities, listed in the database to discover which other entites are functionally complementary to them. By including a SIC number, a more exact match is able to be made between these entities.

The primary objective of the present invention method is to enable matching of complementary business interests of business entities listed in a large scale public database accessible through the Internet, on line.

A further objective is to provide such a method using a standard industrial code to establish common interests between business entities listed in the database.

A still further objective is to provide such a method for matching available technology and products to business entities eager to exploit such assets.

Other features and advantages of the present invention method will become apparent from the following more detailed description, which shows, by way of example, the principles of the invention.

### DETAILED DESCRIPTION OF THE FIGURES

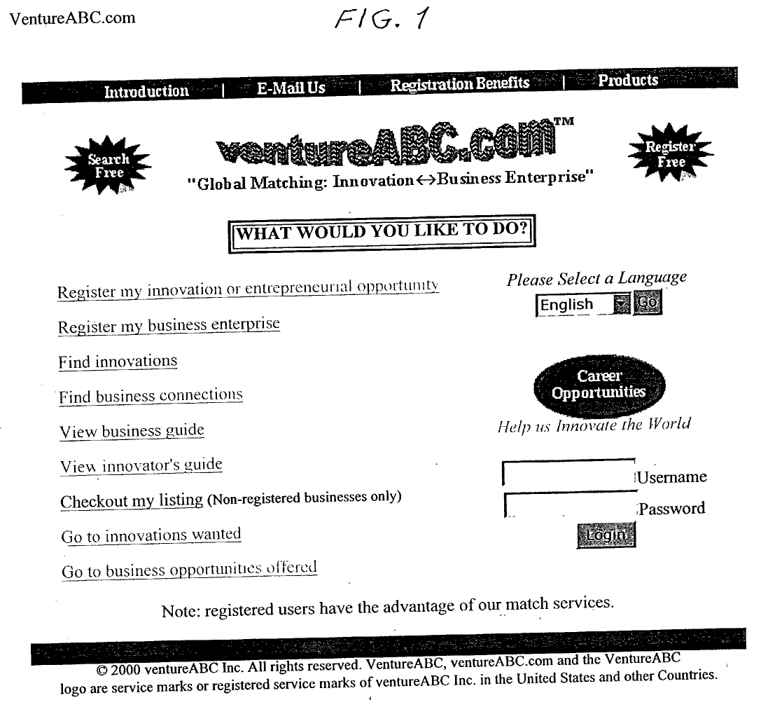

FIG. 1 is a computer screen view of a home page of an Internet web site embodying the present invention;

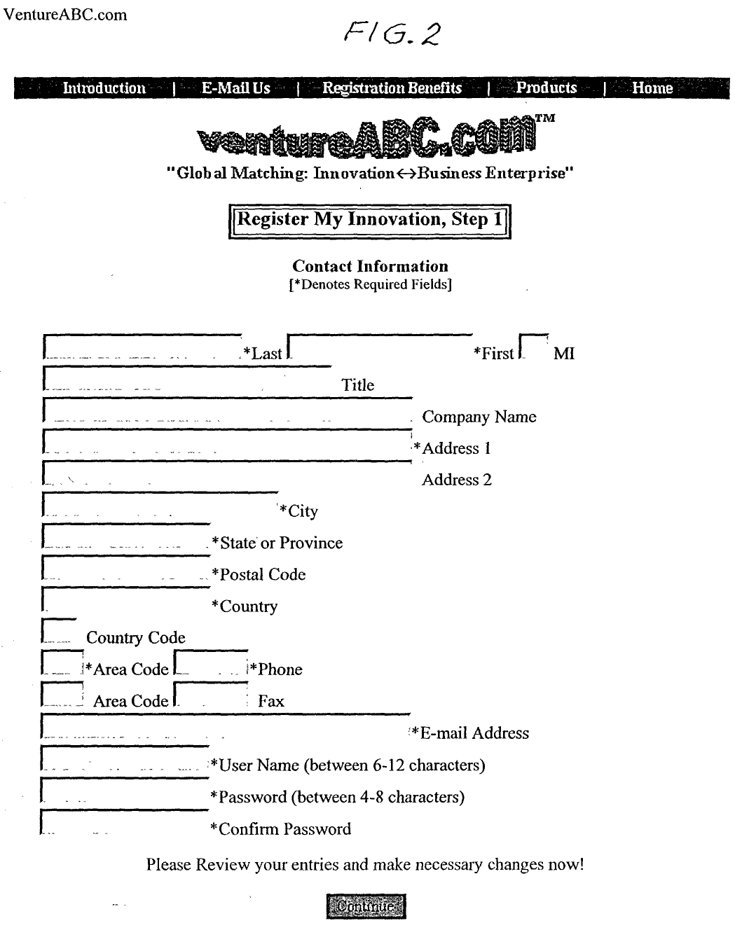

FIG. 2 is a computer screen view of a contact information input page thereof;

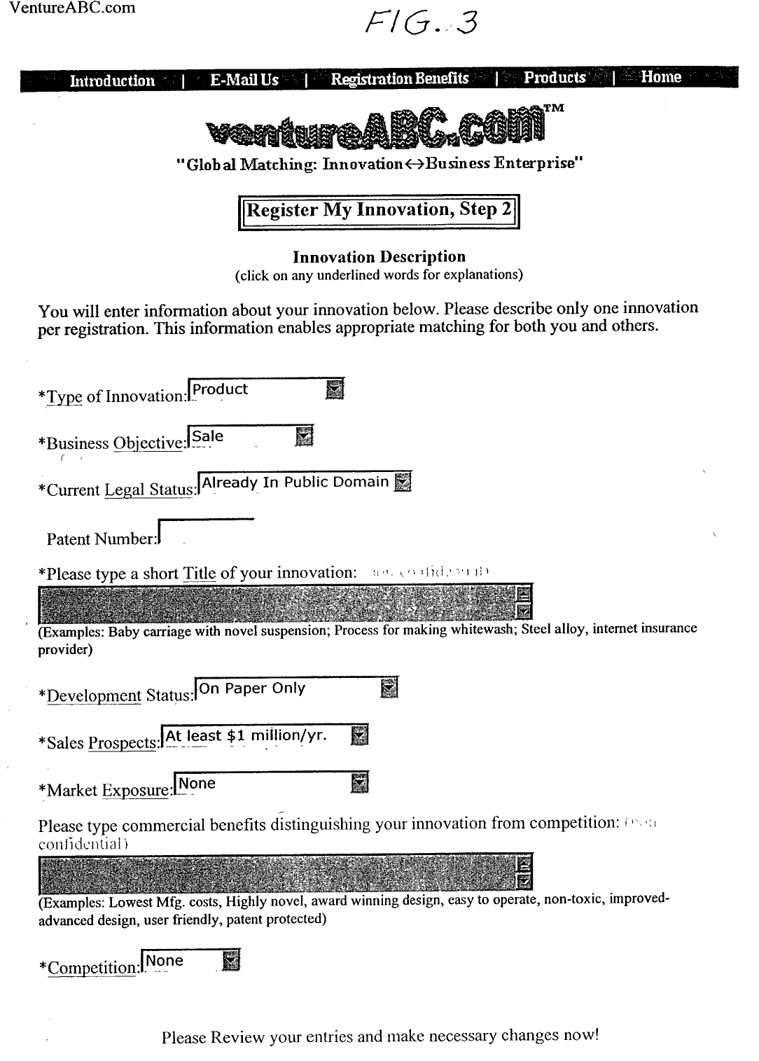

FIG. 3 is a computer screen view of an invention disclosure information input page thereof; and

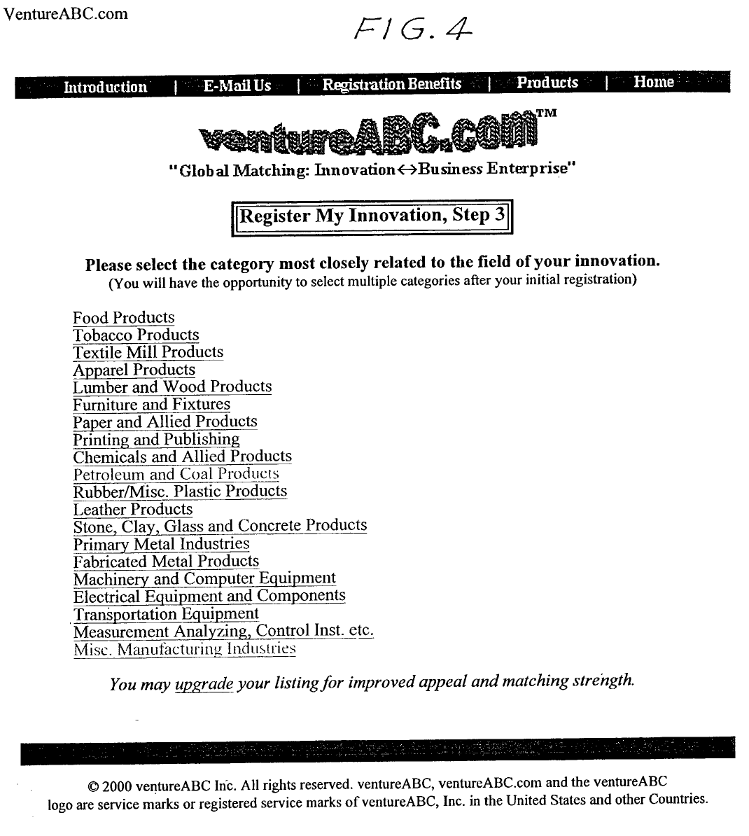

FIG. 4 is a computer screen view of an SIC information input page thereof.

### DETAILED DESCRIPTION OF THE INVENTION

The invention defines a method for matching each of a diversity of intellectual properties with a further diversity of business enterprises for exploitation of the intellectual properties. The method, in its simplest form comprises the steps of identifying a first Standard Industrial Code (SIC) number, which is assigned to a field of business wherein the intellectual property might be of use; identifying a second SIC number assigned to at least one field of business of the business enterprise; listing the intellectual property in a searchable electronic database, wherein the intellectual property is cataloged under the first SIC number; listing the business enterprise in the database, wherein the business enterprise is cataloged under the second SIC number; and searching the database using one of the first and second SIC numbers to find a match between the intellectual property and the business enterprise when the first SIC number equals the second SIC number. Clearly, the foregoing describes the basic use of a database that might comprise many thousands of such intellectual properties (IP) and business enterprises so that IP creators may more easily find businesses that have a need for their creations, and so that such businesses may search to find IP that may be helpful to them in improving methods, creating new products and the like.

Certainly, the business enterprise that we speak of herein may be a service related enterprise enabled for helping to develop the intellectual property into a commercially attractive business asset. Such service businesses may be an engineering firm, a manufacturer, a distributor, a marketing firm, a source of new business venture capital, a law firm, an engineering development firm or a business development consulting firm. Such services play an important part in the creation and development of intellectual properties such as those protected by patent, trade secret, trademark and copyright.

In its most important embodiment, the present invention method is practiced by making the database available to the general business public via the Internet. In this way the service of matching such entities is made available on a global basis and to a great diversity of business people of all walks of life and with a vast range of creativity and business capability. To accomplish this, the step of installing a large scale business data into the database is taken, where the data represents at least a business-wise significant portion of the set of all business enterprises comprising manufacturers, distributors, marketing firms, sources of new business venture capital, law firms, engineering development firms, business development firms and the like, located in at least one geopolitical area. Further, preferably, the intellectual property data represents at least a business-wise significant portion of the set of all unexploited patents pending and trade secrets created in, at least one, and preferably the same, geopolitical area a for the business entities. The business-wise significant portion is herein defined as a quantity of entities as may reasonably constitute a range of choice of such magnitude as to satisfy the needs of a majority of users.

The instant invention is most effectively carried out by including the step of registering users (users of the Internet site and the database) in the database, wherein each of the users provides at least one of the listings of the IP and business enterprises in the database. Such a user is thereafter able to be contacted by other users when a match is made by them and may make a match him/herself. The registration step, inventively, comprises the step of selecting a representative SIC code from an index to SIC codes, where the SIC code represents the field of business most closely related to the IP or business enterprise registered in the database.

The FIGS. 1-4 show various data input screens which may be filled-in by users while on line and connected to the Internet site. An SIC number is selecting during user registration from an SIC index, a portion of which is shown in FIG. 4. Once this information is installed into the database a simple software program matches the SIC numbers of the several users. A user seeking a match is then able to view a list of potential matches and may then elect to contact the users represented thereby for initializing business discussions.

Since the Internet is accessible to most of the countries of the World, the instant method comprising the step of publishing the database in a plurality of languages. Each user may select the language of his or her own choice.

It should be understood that most intellectual properties are maintained in secrecy until well along in the commercial exploitation process. Even IP that is published is usually still maintained at a certain level of secrecy. The instant method therefore includes the important step of restricting the description of registered IP to only its benefits and particularly not divulging its technical know-how. As an example, let us assume that a registered IP relates to a new petroleum fractional distillation process. In this case a title for the IP might be entered into the database as, “Low Cost Fractional Distillation Of Petroleum.” Benefits may be then recited as: “Low Processing Cost,” “Low Investment,” “Improved Yield,” and “Superior Petroleum Cuts.” The purpose of the matching process is to introduce those with similar business objectives to each other. The database is not a technical resource, but rather a business tool.

In a further embodiment of the invention, the method is used for matching business entities and comprises the steps of:

a) creating a business entity database including individual records, each of the records identifying a business entity by business name, address, phone, contact person, etc.;

b) recording a Seeking, an Offering and a SIC for each said entity, where a Seeking is one or more business assets from a fixed list of such assets, that is sought by the entity, such as products, services, working capital, and new technology (inventions), and where an Offering is one or more of the latter that are assets offered by the entity, and the SIC, as defined above is the standard industrial code of the entity;

c) providing public access to the database for searching in the records, as is known in the art;

d) recording a Seeking and a SIC for each searcher that wants to use the database, and this is accomplished by enabling the searcher to select from lists of SIC divisions, classifications and sub-classifications;

e) compiling, for each searcher Seeking and SIC, all matching entity Seekings, entity Offerings and corresponding entity SIC in the records of the database; and

f) presenting, to the searcher, contact information corresponding to each match.

Preferably, the entity Offerings are invention disclosures and the method further comprises the step, for each of the invention disclosures, of identifying at least one SIC related to a field of use of the invention. Preferably, the disclosures are each restricted to a list of non-patentable benefits, excludes how to make and use the corresponding invention. Thus, inventions that are not protected by patent pending, such as trade secrets, may be offered for commercial evaluation.

The entity Offerings may be published patent applications or granted patents where the method further comprises the step, for each of the patent applications or grants, of identifying at least one SIC related to a patent class code of the patent application.

Clearly, the method may further comprise the steps of: matching complimentary Seekings and Offerings for pairs of entities in the database which have a common SIC; and presenting to the pairs of entities, contact information corresponding to each match.

It is critical to limit the Offerings and Seekings options to entities in the database to the categories of: business services, customers, inventions, venture capital, venture partners, collaborators, and products. These categories provide all of the possible opportunities available to companies interested in venture activities, and as such, form a database structure that is at once comprehensive and extremely useful. The actual live site used currently provides 1.2 million business entities and over 100,000 inventions and this is being increased daily. The number of business entities in the database will be at least 11 million within a short time. To function effectively with such large data stores, the present method has been found to be efficient and effective to its users. Please see; ventureABC.com.

While the invention has been described with reference to at least one preferred embodiment, it is to be clearly understood by those skilled in the art that the invention is not limited thereto. Rather, the scope of the invention is to be interpreted only in conjunction with the appended claims.

1. A method for matching business entities comprising the steps of:
a) creating a business entity database including individual records, each of the records identifying a single business entity;
b) recording an Offering as a disclosure of an invention, for each of a portion of the business entities and at least one SIC corresponding to a field of use of the invention;
c) recording a Seeking disclosure for each of a portion of the business entities and a related, at least one SIC corresponding to a field of use of the Seeking;
d) providing public access to the database for searching in the records;
e) recording a Seeking and a SIC for each searcher;
f) compiling, for each searcher Seeking and SIC, all matching entity Offerings and corresponding entity SIC in the records; and
g) presenting, to the searcher, contact information corresponding to each match.

2. The method of claim 1 wherein the invention disclosures are each restricted to a list of non-patentable benefits, said list excluding how to make and use the corresponding invention.

3. The method of claim 2 wherein the invention disclosures are trade secrets.

4. The method of claim 1 wherein the entity Offerings are published patent applications and further comprising the step, for each of the patent applications, of identifying at least one SIC related to a patent class code of the patent application.

5. The method of claim 1 wherein the entity Offerings are granted patents and further comprising the step, for each of the granted patents, of identifying at least one SIC related to a patent class code of the patent.

6. The method of claim 1 further comprising the steps of: matching complimentary Seekings and Offerings for pairs of entities having a common SIC; and presenting to the pairs of entities, contact information corresponding to each match.

7. The method of claim 1 wherein the Seekings and the Offerings are limited to business services, customers, inventions, venture capital, venture partners, collaborators, and products.
